(19) United States
(12) Patent Application Publication
(10) Pub. No.: US 2023/0356086 A1
(43) Pub. Date: Nov. 9, 2023

(54) METHOD AND APPARATUS FOR CONTROLLING VIRTUAL OBJECT, TERMINAL, STORAGE MEDIUM AND COMPUTER PROGRAM PRODUCT

(71) Applicant: TENCENT TECHNOLOGY (SHENZHEN) COMPANY LIMITED, Shenzhen (CN)

(72) Inventor: Zhihong LIU, Shenzhen (CN)

(73) Assignee: TENCENT TECHNOLOGY (SHENZHEN) COMPANY LIMITED, Shenzhen (CN)

(21) Appl. No.: 18/352,702

(22) Filed: Jul. 14, 2023

Related U.S. Application Data
(63) Continuation of application No. PCT/CN2021/142176, filed on Dec. 28, 2021.

(30) Foreign Application Priority Data
Feb. 5, 2021 (CN) 202110164953.1

(51) Int. Cl. A63F 13/57; A63F 13/52

(52) U.S. Cl. CPC A63F 13/57; A63F 13/52

(57) ABSTRACT

Embodiments of this application disclose a method and an apparatus for controlling a virtual object, and a storage medium storing computer program code. The method includes displaying an object control interface based on a camp to which a first virtual object belongs; controlling the first virtual object to execute camp tasks corresponding to the camp to which the first virtual object belongs, in response to a control operation in the object control interface; and displaying a game result through a game end interface, in response to the performed camp task meeting a game end condition. Camp tasks corresponding to the first camp include maintaining a virtual device in a virtual environment and defeating the virtual object belonging to the second camp. Camp tasks corresponding to the second camp include destroying the virtual device in the virtual environment and defeating the virtual object belonging to the first camp.

### CROSS-REFERENCE TO RELATED APPLICATIONS

This application is a continuation of International Application No. PCT/CN2021/142176, filed on Dec. 28, 2021, which claims priority to Chinese Patent Application No. 202110164953.1, filed on Feb. 5, 2021, both of which are incorporated herein by reference in their entirety.

### FIELD

The present disclosure relates to the field of computer technologies, and in particular, to a method and an apparatus for controlling a virtual object, a terminal, a storage medium and a computer program product.

### BACKGROUND

A battle game is a game in which a plurality of user accounts compete in the same scene. A player may control a virtual object in a virtual environment to perform actions such as walking, running, climbing, shooting and the like, and a plurality of players may team up online to collaboratively complete a task in the same virtual environment. During the game, the players may control the virtual objects to attack the virtual objects of a rival camp. When all virtual objects in one camp are defeated, the game ends and the other camp wins the game.

However, a game mode in a related technology is to only defeat the virtual objects of the rival camp as a competitive goal when the camps are known, so that certain players may evade by looking at positions of the virtual objects of all camps, and rely on a strategy of other players in the same camp to defeat the virtual objects of the rival camp to engage in a passive battle. In this way, human-computer interaction efficiency is low, which delays a game duration, increases burden of a server to process a single game and makes hardware resource utilization low.

### SUMMARY

Embodiments of this application provide a method and an apparatus for controlling a virtual object, a terminal, and a storage medium, which can shorten a game duration, and improve human-computer interaction efficiency and hardware resource utilization.

In accordance with certain embodiments of the present disclosure, a method is provided for controlling a virtual object. The method may be executed by a terminal. The method may include displaying an object control interface based on a camp to which a first virtual object belongs. The camp may include a first camp and a second camp. The method may further include controlling the first virtual object to execute a camp task corresponding to the camp to which the first virtual object belongs, in response to a control operation in the object control interface. A first camp task of a plurality of camp tasks and corresponding to the first camp may include at least one of maintaining a virtual device in a virtual environment and defeating the virtual object belonging to the second camp. A second camp task of the plurality of camp tasks and corresponding to the second camp may include at least one of destroying the virtual device in the virtual environment and defeating the virtual object belonging to the first camp. The method may further include displaying a game result through a game end interface, in response to the executed camp task meeting a game end condition.

In accordance with other embodiments of the present disclosure, an apparatus is provided for controlling a virtual object. The apparatus may include at least one memory configured to store computer program code. The apparatus may further include at least one processor configured to operate as instructed by the computer program code. The computer program code may include first display code configured to cause the at least one processor to display an object control interface based on a camp to which a first virtual object belongs. The camp may include a first camp and a second camp. The computer program code may further include first control code configured to cause the at least one processor to control the first virtual object to execute a camp task corresponding to the camp to which the first virtual object belongs, in response to a control operation in the object control interface. A first camp task of a plurality of camp tasks and corresponding to the first camp may include at least one of maintaining a virtual device in a virtual environment and defeating the virtual object belonging to the second camp. A second camp task of the plurality of camp tasks and corresponding to the second camp may include at least one of destroying the virtual device in the virtual environment and defeating the virtual object belonging to the first camp. The computer program code may further include second display code configured to cause the at least one processor to display a game result through a game end interface, in response to the executed camp task meeting a game end condition.

In accordance with still other embodiments of the present disclosure, a non-transitory computer-readable storage medium is provided for storing computer program code. The computer program code, when executed by at least one processor, may cause the at least one processor to display an object control interface based on a camp to which a first virtual object belongs. The camp may include a first camp and a second camp. The computer program code may further cause the at least one processor to control the first virtual object to execute a camp task corresponding to the camp to which the first virtual object belongs, in response to a control operation in the object control interface. A first camp task of a plurality of camp tasks and corresponding to the first camp may include at least one of maintaining a virtual device in a virtual environment and defeating the virtual object belonging to the second camp. A second camp task of the plurality of camp tasks and corresponding to the second camp may include at least one of destroying the virtual device in the virtual environment and defeating the virtual object belonging to the first camp. The computer program code may further cause the at least one processor to display a game result through a game end interface, in response to the executed camp task meeting a game end condition.

Beneficial effects brought by the technical solutions provided in certain embodiments of this disclosure include the following:

In certain embodiments of this disclosure, a first camp task of a first camp includes: maintaining a virtual device in a virtual environment and defeating a virtual object belonging to a second camp, and a second camp task of a second camp includes destroying the virtual device in the virtual environment and defeating a virtual object belonging to the first camp. That is, for the first camp and the second camp, there are two corresponding camp tasks. During a battle, the virtual object may perform at least one of the two camp tasks according to its own camp, so that a competitive target is not just to defeat a rival virtual object. In this way, a user may be urged to control the virtual object to move in the virtual environment and select a camp task to be performed according to an actual situation, which solves the problem that the game cannot be completed by defeating the virtual object in a case of passive battle, improves the participation of the game and human-computer interaction efficiency, effectively controls a duration of a single game and to-be-processed data volume of a server, and improves hardware resource utilization.

### BRIEF DESCRIPTION OF THE DRAWINGS

To describe the technical solutions of example embodiments of this disclosure more clearly, the following briefly introduces the accompanying drawings for describing the example embodiments. The accompanying drawings in the following description show only certain embodiments of the disclosure, and a person of ordinary skill in the art may still derive other drawings from these accompanying drawings without creative efforts. In addition, one of ordinary skill would understand that aspects of example embodiments may be combined together or implemented alone.

FIG. 1 is a schematic diagram of an implementation environment according to certain embodiments of this application;

FIG. 2 is a schematic flowchart of a method for controlling a virtual object according to certain embodiments of this application;

FIG. 3 is a schematic flowchart of a method for controlling a virtual object according to certain embodiments of this application;

FIG. 4 is a schematic diagram of an object control interface according to certain embodiments of this application;

FIG. 5 is a schematic diagram of maintaining a target virtual device according to certain embodiments of this application;

FIG. 6 is a schematic diagram of determining a distance between a virtual device and a first virtual object according to certain embodiments of this application;

FIG. 7 is a schematic flowchart of a method for controlling a virtual object according to certain embodiments of this application;

FIG. 8 is a schematic diagram of damaging a target virtual device according to certain embodiments of this application;

FIG. 9 is a schematic diagram of damaging a target virtual device according to certain embodiments of this application;

FIG. 10 is a schematic flowchart of a method for controlling a virtual object according to certain embodiments of this application;

FIG. 11 is a schematic diagram of a game end interface and a game detail interface according to certain embodiments of this application;

FIG. 12 is a schematic flowchart of a method for controlling a virtual object according to certain embodiments of this application;

FIG. 13 is a schematic diagram of a check interface according to certain embodiments of this application;

FIG. 14 is a schematic flowchart of a method for controlling a virtual object according to certain embodiments of this application;

FIG. 15 is a schematic flowchart of a virtual object list according to certain embodiments of this application;

FIG. 16 is a schematic flowchart of a method for controlling a virtual object according to certain embodiments of this application;

FIG. 17 is a structural block diagram of an apparatus for controlling a virtual object according to certain embodiments of this application; and

FIG. 18 is a structural block diagram of a terminal according to certain embodiments of this application.

### DESCRIPTION OF EMBODIMENTS

To make objectives, technical solutions, and advantages of this application clearer, the following further describes in detail implementations of this application with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “certain embodiments” describe a subset of all possible embodiments. However, it may be understood that the “certain embodiments” may be the same subset or different subsets of all the possible embodiments, and may be combined with each other without conflict.

“Plurality of” mentioned in the specification means two or more. “And/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

First, terms as used in certain embodiments of this application are introduced.

1) Virtual Environment

A virtual environment is displayed (or provided) when an application program runs on a terminal. The virtual environment may be a simulated environment of a real world, or may be a semi-simulated semi-fictional three-dimensional environment, or may be an entirely fictional three-dimensional environment. The virtual environment may be any one of a two-dimensional virtual environment, a 2.5-dimensional virtual environment, and a three-dimensional virtual environment. A description is made by using an example in which the virtual environment is a three-dimensional virtual environment in the following embodiment, but it is not limited thereto. In certain embodiments, the virtual environment may be further used for a virtual environment battle between at least two virtual characters, and there may be virtual resources available to the at least two virtual characters in the virtual environment.

2) Virtual Object

A virtual object is a movable object in a virtual scene. The movable object may be at least one of a virtual character, a virtual animal, and a cartoon character. In certain embodiments, in a case that the virtual scene is a three-dimensional virtual scene, the virtual object may be a three-dimensional model. Each virtual object has a shape and a volume in the three-dimensional virtual scene, and occupies a space in the three-dimensional virtual scene. In certain embodiments, the virtual character may be a three-dimensional character constructed based on a three-dimensional human skeleton technology. The virtual character may wear different skins to implement different appearances. In certain implementations, the virtual character may further be implemented by using a 2.5-dimensional model or a two-dimensional model, but the embodiments are not limited thereto.

3) Virtual Prop

A virtual prop is a prop that the virtual object can use in the virtual environment. In certain embodiments, the virtual prop may be a virtual interactive prop that is used for the virtual object to interact with other virtual objects in the virtual environment. For example, the virtual prop may be a virtual prop that can harm the other virtual objects. In certain embodiments, the virtual prop may further be a replenishment prop used to offer supply to the interactive prop. For example, when the interactive prop is a shooting prop, the virtual prop as the replenishment prop may be a virtual bullet of the shooting prop. In certain embodiments, the virtual prop may further be a defensive prop used by the virtual object to defend against attacks by other virtual objects, or a virtual prop such as a virtual beam, a virtual shock wave and the like used to display through a hand when the virtual object releases a skill, and parts of a body of the virtual object, such as a hand and a leg.

4) Virtual Device

A virtual device is an instrument and a device in the virtual environment, including a computer device, a communication device, a water tower, a generator and the like. In the embodiments of the application, the virtual device may be damaged or destroyed by a virtual object of a second camp, and the virtual device in a damaged state may be maintained by a virtual object of a first camp.

5) User Interface Control

Any visual control or element that can be seen in a UI of an application program, such as: a control such as a picture, an input box, a text box, a button, a label, or the like. Some UI controls respond to an operation of a user.

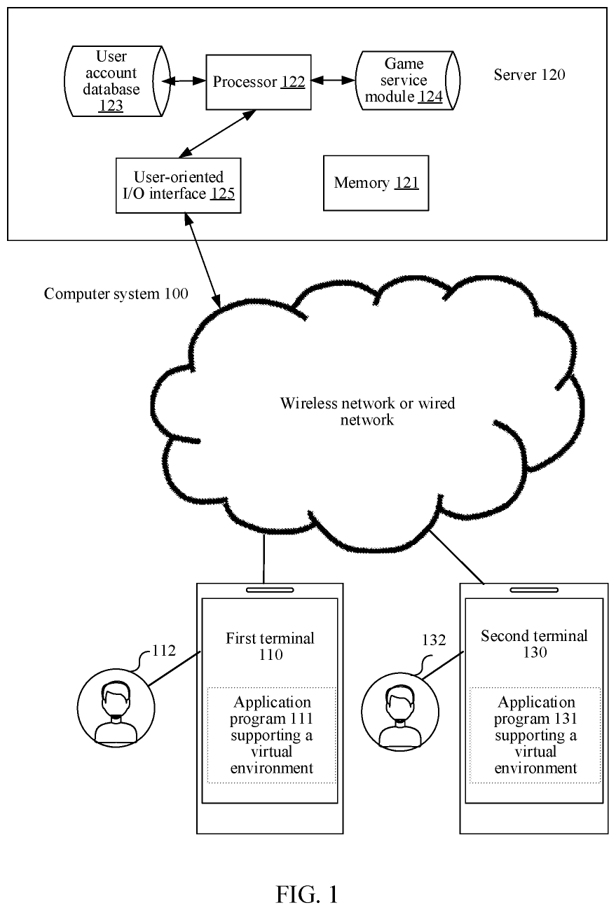

FIG. 1 is a schematic diagram of an implementation environment according to certain embodiments of this application. The implementation environment may include: a first terminal 110, a server 120, and a second terminal 130.

An application program 111 supporting a virtual world may be installed and run on the first terminal 110, and the application program 111 may be a multiplayer online battle program. When the first terminal runs the application program 111, a UI of the application program 111 is displayed on a screen of the first terminal 110. The application program 111 may be a multiplayer online battle arena (MOBA) game and a simulation game (SLG). In this embodiment, an example in which the application program 111 is a MOBA game is used for description. The first terminal 110 is a terminal used by a first user 112. The first user 112 uses the first terminal 110 to control a first virtual object located in the virtual world to perform activities, and the first virtual object may be referred to as a main control virtual object of the first user 112. The activities of the first virtual object include but are not limited to: at least one of adjusting body postures, crawling, walking, running, riding, flying, jumping, driving, picking, object interacting, throwing, and skill casting. Schematically, the first virtual object is a first virtual character such as a simulated character or a cartoon character. In certain embodiments, the first virtual object belongs to the first camp or the second camp. When the first virtual object belongs to the first camp, camp information of the virtual object in the second camp is invisible in the object control interface displayed by the first terminal 110. The first user 112 controls the first virtual object to defeat the virtual object in the second camp and maintains the virtual device in the virtual environment to win. When the first virtual object belongs to the second camp, camp information of the virtual object in the first camp is visible in the object control interface displayed by the first terminal 110. The first user 112 controls the first virtual object to defeat the virtual object in the first camp and destroys the virtual device in the virtual environment to win.

An application program 131 supporting a virtual world is installed and run on the second terminal 130, and the application program 131 may be a multiplayer online battle program. When the second terminal 130 runs the application program 131, a UI of the application program 131 is displayed on a screen of the second terminal 130. The client may be a MOBA game, and a SLG game. In this embodiment, an example in which the application program 131 is a MOBA game is used for description. The second terminal 130 is a terminal used by a second user 132. The second user 132 uses the second terminal 130 to control a second virtual object located in the virtual world to perform activities, and the second virtual object may be referred to as a main control virtual character of the second user 132. Schematically, the second virtual object is a second virtual character, such as a simulated character or a cartoon character. In certain embodiments, the second virtual object belongs to the first camp or the second camp. When the second virtual object belongs to the first camp, camp information of the virtual object in the second camp is invisible in the object control interface displayed by the second terminal 130. The first user 112 controls the second virtual object to defeat the virtual object in the second camp and maintains the virtual device in the virtual environment to win. When the second virtual object belongs to the second camp, camp information of the virtual object in the first camp is visible in the object control interface displayed by the second terminal 130. The first user 112 controls the second virtual object to defeat the virtual object in the first camp and destroys the virtual device in the virtual environment to win.

In certain embodiments, the first virtual object and the second virtual object are in the same virtual world. The first virtual object and the second virtual object may belong to the same camp, the same team, or the same organization, and have a friend relationship, or have a temporary communication permission. In certain embodiments, the first virtual object and the second virtual object may belong to different camps, different teams, or different organizations, or have a hostile relationship with each other.

In certain embodiments, the application program installed on the first terminal 110 and the second terminal 130 are the same, or the application program installed on the two terminals are the same type of application programs on different operating system platforms (Android system or IOS system). The first terminal 110 may generally refer to one of a plurality of terminals, and the second terminal 130 may generally refer to another one of the plurality of terminals. In this embodiment, the first terminal 110 and the second terminal 130 are merely used as an example for description. The device types of the first terminal 110 and the second terminal 130 may be the same or different. The device types may include: at least one of a smartphone, a tablet computer, an e-book reader, an MP3 player, an MP4 player and a laptop portable computer, and a desktop computer.

FIG. 1 shows only two terminals. However, a plurality of other terminals may access the server 120 in different embodiments. In certain embodiments, one or more terminals are terminals corresponding to a developer. A developing and editing platform for the application program supporting the virtual world may be installed on the terminal. The developer may edit and update the application program on the terminal and transmit an updated application program installation package to the server 120 by using a wired or wireless network. The first terminal 110 and the second terminal 130 may download the application program installation package from the server 120 to update the application program.

The first terminal 110, the second terminal 130, and the other terminals are connected to the server 120 through a wireless network or a wired network.

The server 120 includes at least one of a server, a server cluster formed by a plurality of servers, a cloud computing platform, and a virtualization center. The server 120 is configured to provide a backend service for an application program supporting a three-dimensional virtual world. In certain embodiments, the server 120 is responsible for primary computing work, and the terminal is responsible for secondary computing work; or the server 120 is responsible for secondary computing work, and the terminal is responsible for primary computing work; or the server 120 and the terminal perform collaborative computing by using a distributed computing architecture between each other.

In a schematic example, the server 120 includes a memory 121, a processor 122, a user account database 123, a battle service module 124, and a user-oriented input/output (I/O) interface 125. The processor 122 is configured to load instructions stored in the server 120, and process data in the user account database 123 and the battle service module 124. The user account database 123 is configured to store data of user accounts used by the first terminal 110, the second terminal 130, and the other terminals, such as avatars of the user accounts, nicknames of the user accounts, battle effectiveness indexes of the user accounts, and service zones of the user accounts. The battle service module 124 is configured to provide a plurality of battle rooms for the users to battle, such as a 1V1 battle room, a 3V3 battle room, a 5V5 battle room, and the like. The user-oriented I/O interface 125 is configured to establish communication between the first terminal 110 and/or the second terminal 130 through the wireless network or the wired network for data exchange.

In the related art, after the server matches the virtual objects participating in the game, the terminal displays the camp information of both sides of the game before the start of the game based on a matching result. The terminal provides the user with real-time camp information of other virtual objects within the field of view of the first virtual object by setting camp identifiers for the virtual objects and different display effects for the virtual objects of different camps during the game. The terminal obtains the locations of the virtual objects of all camps through a map representation control, so that the user can control the first virtual object to cooperate with the virtual object of the same camp and avoid the virtual object of a rival camp. In certain embodiments, for the virtual object of the first camp, the camp information of other virtual objects except for itself is invisible. The user cannot directly obtain the camp information of virtual objects through the object control interface, so that a strategy of relying on the virtual object of the same camp to avoid attacks cannot be adopted, and both sides of the game need to win the game by defeating the rival virtual object and maintaining or destroying the virtual device. Compared with the method in the related art in which the camp information is known and only defeating the rival virtual object is needed, this method can solve the problem that the game cannot be completed by defeating the virtual object in a case of passive battle, increase competitiveness and strategy during the battle, effectively control a duration of a single game, and improve human-computer interaction efficiency and hardware resource utilization.

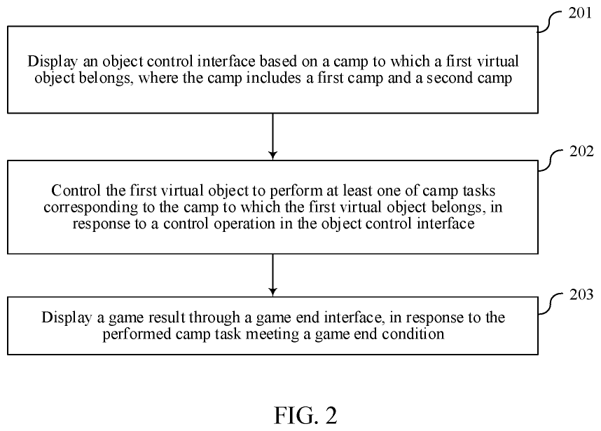

FIG. 2 is a flowchart of a method for controlling a virtual object according to certain embodiments of this application. This embodiment is described by using an example in which the method is applied to the first terminal 110 or the second terminal 130 in the implementation environment shown in FIG. 1 or other terminals in the implementation environment. The method includes:

Operation 201: Display an object control interface based on a camp to which a first virtual object belongs, where the camp includes a first camp and a second camp.

In certain embodiments, in the object control interface, camp information of a virtual object in the first camp is visible to a virtual object in the second camp, and camp information of the virtual object in the second camp is invisible to the virtual object in the first camp.

In certain embodiments, a game includes two camps. A user needs to control the first virtual object to compete with the virtual object of the rival camp to win the camp of the first virtual object. The camp information of the virtual object in the first camp is visible to the virtual object in the second camp, and the camp information of the virtual object in the second camp is invisible to the virtual object in the first camp. That is, when the first virtual object belongs to the first camp, the user cannot know camp information of other virtual objects in a virtual environment. When the first virtual object belongs to the second camp, the user can obtain the virtual object included in the second camp through the object control interface, so as to know camp information of all virtual objects.

For example, the virtual objects in the game have two different characters, namely, a first character (the first camp) and a second character (the second camp). The first character cannot know whether the other virtual objects in the virtual environment are the first character or the second character, but the second characters can mutually confirm identities, so that the user corresponding to the second character can infer the first character in the virtual environment.

In certain embodiments, when the first virtual object belongs to the first camp, the camp information of the virtual object in the second camp in the object control interface displayed by the terminal is invisible (that is, the camp information of the other virtual objects except for the first virtual object is invisible). When the first virtual object belongs to the second camp, in the object control interface displayed by the terminal, display modes of virtual objects of different camps are different (for example, the virtual objects carry different camp identifiers, or colors of the virtual objects are different). Or, the object control interface displayed by the terminal contains an object list used for displaying the virtual object of the second camp, or the object control interface displayed by the terminal contains a control used for triggering the display of the camp information of the virtual object, or the like. The embodiments are not limited thereto.

In certain embodiments, at the beginning of the game, the quantity of the virtual objects allocated to the first camp and the second camp is the same, or the quantity of the virtual objects of the first camp is greater than that of the second camp, or the quantity of the virtual objects of the first camp is less than that of the second camp.

Schematically, in the object control interface, the camp information of the virtual object in the first camp is visible to the virtual object in the second camp, and the camp information of the virtual object in the second camp is invisible to the virtual object in the first camp. Therefore, to compete fairly and avoid a high probability of the second camp winning, the quantity of the virtual objects allocated to the first camp is greater than the quantity of the virtual objects allocated to the second camp. For example, when a server performs game matching, the quantity of the virtual objects in the second camp is controlled to be one-third of the quantity of the virtual objects in the first camp (rounded up), and the principle that the virtual object corresponding to the user matched in a team is allocated to the same camp as much as possible is adopted. When the quantity of the virtual objects in the same team is less than or equal to a maximum quantity of the virtual objects in the second camp, the whole team of the virtual objects is randomly allocated to the first camp, or the whole team of the virtual objects is backed up and allocated to the second camp, When the quantity of the virtual objects in the same team is greater than the maximum quantity of the virtual objects in the second camp and less than a maximum quantity of the virtual objects in the first camp, the whole team of the virtual objects is allocated to the first camp. When the quantity of the virtual objects in the same team is greater than the maximum quantity of the virtual objects in the first camp, virtual objects in the team are randomly allocated to the first camp or the second camp.

Operation 202: Control the first virtual object to perform at least one of camp tasks corresponding to the camp to which the first virtual object belongs, in response to a control operation in the object control interface.

A first camp task of the first camp includes: maintaining a virtual device in a virtual environment and defeating the virtual object belonging to the second camp, and a second camp task of the second camp includes destroying the virtual device in the virtual environment and defeating the virtual object belonging to the first camp.

The user wins the game by controlling the virtual object to perform the camp task, where the camp task includes both defeating the virtual object of the rival camp, and maintaining or destroying the virtual device. In certain embodiments, at the beginning of the game, the server randomly determines an operable virtual device in the virtual environment. If the first virtual object belongs to the second camp, the user can control the first virtual object to destroy the virtual device through the control operation, and defeat the virtual object of the first camp to prevent the virtual device from being maintained. If the first virtual object belongs to the first camp, the user can control the first virtual object to maintain the virtual device through the control operation and defeat the virtual object of the first camp to prevent the virtual device from being destroyed. During the battle, the user corresponding to the virtual object of the first camp can guess the camp information by observing the behavior of other virtual objects.

Operation 203: Display a game result through a game end interface, in response to the performed camp task meeting a game end condition.

When in the first camp and the second camp, the virtual object of one camp first makes the camp task meet the game end condition, the game ends, and the terminal displays the game end interface. In certain embodiments, the game end condition has different requirements for the first camp task and the second camp task. For example, for the first camp, if all virtual objects of the second camp are defeated, or the quantity of the virtual devices successfully maintained by the first camp reaches a preset quantity, the game ends and the first camp wins. For the second camp, if all virtual objects of the first camp are defeated, or the quantity of the virtual devices successfully destroyed by the second camp reaches a preset quantity, the game ends and the second camp wins.

Schematically, the game result includes the winning camp, and the camp information of all virtual objects.

In conclusion, in the embodiments of this application, the virtual object of the first camp in the camps of both sides of the battle cannot obtain the camp information of other virtual objects except for itself. In addition to defeating the virtual object of the rival camp, the virtual object can further complete the camp task of maintaining or destroying the virtual device. A competitive target is not only to defeat the rival virtual object, but to complete the game by defeating the rival virtual object and maintaining or destroying the virtual device, so that the user can be urged to control the virtual object to move in the virtual environment, which solves the problem that the game cannot be completed by defeating the virtual object in a case of passive battle. Moreover, hiding the camp information can increase the competitiveness and strategy during the battle, and improve the participation in the battle, so as to reduce the situation of passive battle, effectively control a duration of a single game and to-be-processed data volume of a server, and improve human-computer interaction efficiency and hardware resource utilization.

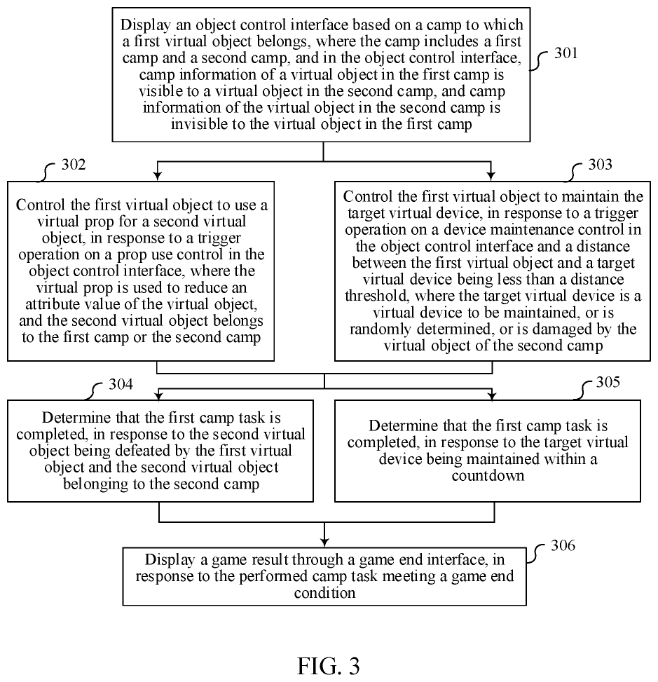

The first camp task of the first camp is different from the second camp task of the second camp. When the first virtual object belongs to the first camp, the user can control the first virtual object to defeat the virtual object of the second camp through the terminal, or maintain the virtual device to be maintained to strive for the victory of the camp. FIG. 3 is a flowchart of a method for controlling a virtual object according to certain embodiments of this application. This embodiment is described by using an example in which the method is applied to the first terminal 110 or the second terminal 130 in the implementation environment shown in FIG. 1 or other terminals in the implementation environment. The method includes the following operations:

Operation 301: Display an object control interface based on a camp to which a first virtual object belongs, where the camp includes a first camp and a second camp, and in the object control interface, camp information of a virtual object in the first camp is visible to a virtual object in the second camp, and camp information of the virtual object in the second camp is invisible to the virtual object in the first camp.

For the specific implementation of Operation 301, reference may be made to Operation 201, and details are not described again in this embodiment of this application.

Operation 302: Control the first virtual object to use a virtual prop for a second virtual object, in response to a trigger operation on a prop use control in the object control interface, where the virtual prop is used to reduce an attribute value of the virtual object, and the second virtual object belongs to the first camp or the second camp.

When the first virtual object belongs to the first camp, a first camp task needing to be completed includes defeating the virtual object of the second camp. Since the virtual object of the first camp cannot know the virtual objects contained in the first camp and the second camp, a user may control the first virtual object to defeat the virtual object of the first camp, or control the first virtual object to defeat the virtual object of the second camp. That is, for the first virtual object, any virtual object in a virtual environment may be defeated.

In certain embodiments, initial virtual props owned by virtual objects are the same, and attribute value of the initial virtual props is relatively low, such as lower than an attribute value threshold. The Virtual prop is scattered at a random place in the virtual environment, or the prop is replenished every predetermined time in the virtual environment. For example, an unmanned aerial vehicle in the virtual environment drops the prop every predetermined time, and a drop place is random. The user can control the virtual object to pick up the virtual prop through the terminal. When the terminal detects that there is a virtual prop that can be picked up within a preset distance of the first virtual object and receives a preset operation, it is determined that the first virtual object is equipped with the virtual prop. Correspondingly, the user can further control the virtual object to discard the unwanted virtual prop into the virtual environment.

Schematically, there is an ordinary virtual prop used to interact or fight with the virtual object and a special virtual prop used to interact or fight with the virtual object in the virtual environment. The special virtual prop may be obtained by assembling an auxiliary sub prop on the ordinary virtual prop. The total quantity of the special virtual props in the virtual environment is less than that of the ordinary virtual props.

To prevent some users from seizing the virtual prop, resulting in uneven resource allocation, the quantity of the virtual props that each virtual object may own is fixed. For example, each virtual object may have up to three virtual props at the same time, and each virtual prop may have up to one at the same time. If the virtual object carries a virtual skill used for expanding equipment, the virtual object may have up to five virtual props at the same time.

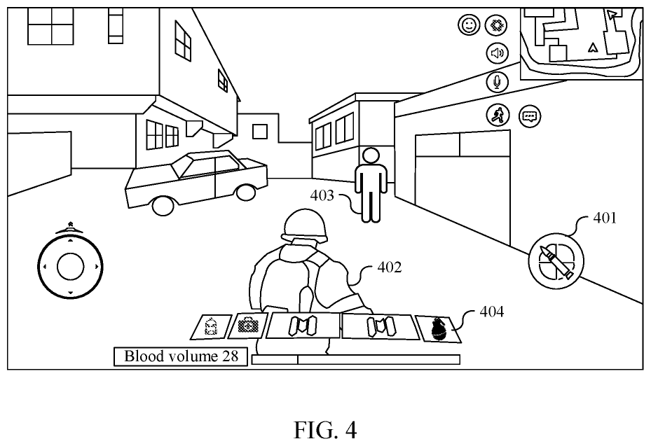

Schematically, as shown in FIG. 4, a prop use control 401 is displayed in the object control interface. When the terminal receives the trigger operation on the prop use control 401 and a first virtual object 402 currently holds the virtual prop, the terminal controls the first virtual object 402 to use the virtual prop. If the virtual prop acts on a second virtual object 403, an attribute value (such as, the remaining life value) of the second virtual object 403 decreases. The user may further change the virtual prop held by the first virtual object by triggering a prop selection control 404.

In certain embodiments, when the game reaches an end-game stage (the current remaining duration is less than or equal to the preset duration), for example, the current remaining duration is 1 minute, the server controls the replenishment in the virtual environment every preset time interval (such as, 15 seconds), and provides a virtual prop with a high attribute value, so as to accelerate the game process.

Operation 303: Control the first virtual object to maintain the target virtual device, in response to a trigger operation on a device maintenance control in the object control interface and a distance between the first virtual object and a target virtual device being less than a distance threshold, where the target virtual device is a virtual device to be maintained, or is randomly determined, or is damaged by the virtual object of the second camp.

When the first virtual object belongs to the first camp, the first camp task needing to be completed further includes maintaining the target virtual device to be maintained in the virtual environment. In certain embodiments, the server randomly generates the virtual device for each game, and randomly determines one or more virtual devices as the target virtual devices from the virtual devices.

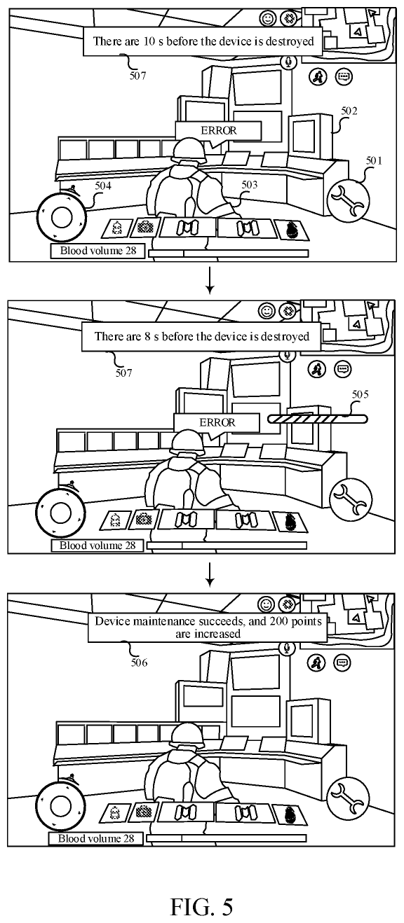

Schematically, as shown in FIG. 5, a device maintenance control 501 and a mobile control 504 are displayed in the object control interface. The user controls the first virtual object 503 to move in the virtual environment by triggering the mobile control 504. Prompt information to be maintained is displayed at the target virtual device. When the distance between the first virtual object 503 and the target virtual device 502 is less than the distance threshold and a trigger operation on the device maintenance control 501 is received, the terminal controls the first virtual object 503 to maintain the target virtual device 502. The first virtual object 503 needs a certain period of time (such as, 3 seconds) to maintain the target virtual device 502. That is, the first virtual object 503 needs to keep the distance between the first virtual object 503 and the target virtual device 502 less than the distance threshold for 3 consecutive seconds after triggering the maintenance for the target virtual device 502, so that the target virtual device 502 can be successfully maintained. The terminal displays a maintenance progress bar 505 through the object control interface, and displays the prompt message of successful maintenance through the object control interface after the first virtual object 503 successfully maintains the target virtual device 502.

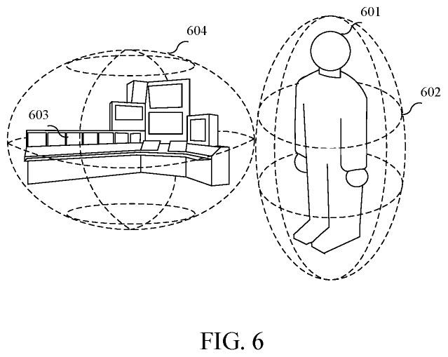

In certain embodiments, the object control interface does not include the device maintenance control. Schematically, the terminal determines whether the first virtual object enters a state of maintaining the target virtual device through a collision box mechanism. As shown in FIG. 6, both the virtual object and the virtual device in the virtual environment are arranged with a collision detection box. When a collision detection box 602 of a first virtual object 601 contacts a collision detection box 604 of a target virtual device 603, it is determined that the first virtual object 601 is repairing the target virtual device 603.

In certain embodiments, after the foregoing Operation 301, the method for controlling a virtual object further includes the following operations:
displaying the target virtual device by using a target display style in the object control interface, causing the display style of the target virtual device to be different from that of another virtual device.

In certain embodiments, the object control interface includes a map representation control. The target virtual device is highlighted in the map representation control of the object control interface.

The object control interface includes the map representation control, where a map screen of the virtual environment within a preset range near the first virtual object is displayed. The terminal displays device identifiers of the virtual devices (such as, device thumbnails, device symbols, and the like) in the map screen, and highlights the target virtual device (for example, the color of the device identifier of a normal virtual device is different from that of the target virtual device), thereby facilitating the user to observe the situation of the virtual devices in the virtual environment.

Operation 304: Determine that the first camp task is completed, in response to the second virtual object being defeated by the first virtual object and the second virtual object belonging to the second camp.

The user defeats the second virtual object by controlling the first virtual object to use the virtual prop. If the second virtual object belongs to the second camp, it is determined that the first virtual object successfully completes the task of defeating the virtual object of the second camp once. If the second virtual object belongs to the first camp, the first virtual object does not complete the first camp task.

Operation 305: Determine that the first camp task is completed, in response to the target virtual device being maintained within a countdown duration.

In certain embodiments, the first virtual object needs to keep the distance between the first virtual object and the target virtual object less than the distance threshold within the preset duration, so that the device may be successfully maintained. The first virtual object needs to successfully maintain the target virtual device for the countdown duration, so that the first camp task may be completed. If the target virtual device is not successfully maintained by the virtual object of the first camp within the countdown duration, it is determined that the target virtual device is destroyed.

When the terminal detects that a virtual device is changed into the target virtual device (that is, the virtual device is damaged), it starts to count down. If the distance between the first virtual object and the target virtual device is not greater than the distance threshold within the countdown duration, it is determined that the first virtual object completes the task of maintaining the virtual device once.

Operation 306: Display a game result through a game end interface, in response to the completed first camp task or the second camp task meeting a game end condition.

For the specific implementation of Operation 306, reference may be made to Operation 203, and details are not described again in this embodiment of this application.

In this embodiment of this application, when the trigger operation on the prop use control is received, the first virtual object is controlled to use the virtual prop, and the first virtual object can defeat the virtual objects of the first camp and the second camp. Only when the second virtual object belongs to the second camp can the first virtual object be determined to complete the first camp task. Only after the first virtual object successfully maintains the target virtual device within the countdown duration can the first camp task be determined to be completed. Thereby, the user cannot avoid and delay the game when the camp information of the virtual objects is clear, which effectively controls the duration of a single game, and improves human-computer interaction efficiency and hardware resource utilization.

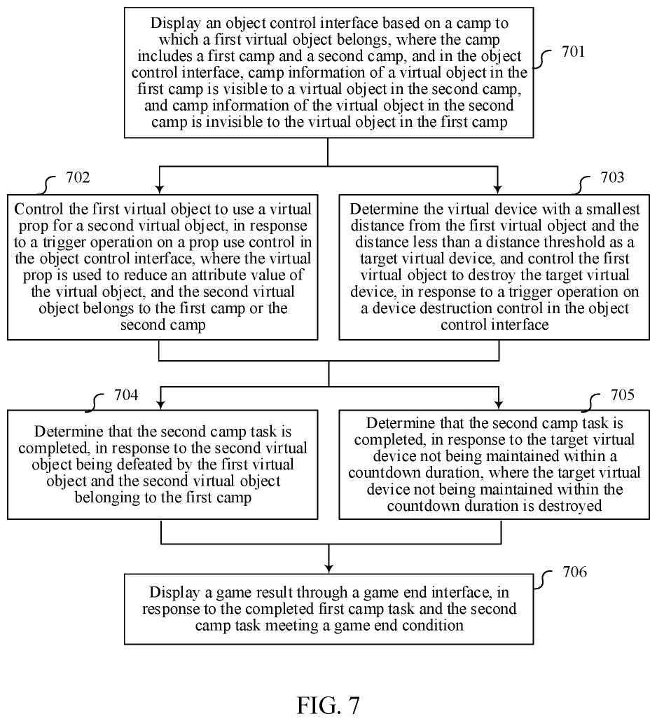

The foregoing embodiment shows the process of executing and completing the first camp task when the first virtual object belongs to the first camp. When the first virtual object belongs to the second camp, the user needs to control the first virtual object to defeat the virtual object of the first camp or destroy the virtual device through the terminal to strive for the victory of the second camp. FIG. 7 is a flowchart of a method for controlling a virtual object according to another exemplary embodiment of this application. This embodiment is described by using an example in which the method is applied to the first terminal 110 or the second terminal 130 in the implementation environment shown in FIG. 1 or other terminals in the implementation environment. The method includes the following operations:

Operation 701: Display an object control interface based on a camp to which a first virtual object belongs, where the camp includes a first camp and a second camp, and in the object control interface, camp information of a virtual object in the first camp is visible to a virtual object in the second camp, and camp information of the virtual object in the second camp is invisible to the virtual object in the first camp.

For the specific implementation of Operation 701, reference may be made to Operation 201, and details are not described again in this embodiment of this application.

Operation 702: Control the first virtual object to use a virtual prop for a second virtual object, in response to a trigger operation on a prop use control in the object control interface, where the virtual prop is used to reduce an attribute value of the virtual object, and the second virtual object belongs to the first camp or the second camp.

When the first virtual object belongs to the second camp, a second camp task needing to be completed includes defeating the virtual object of the first camp. In certain embodiments, for the first virtual object, any virtual object in a virtual environment may be defeated.

Operation 703: Determine the virtual device with a smallest distance from the first virtual object and the distance less than a distance threshold as a target virtual device, and control the first virtual object to damage the target virtual device, in response to a trigger operation on a device damage control in the object control interface.

When the first virtual object belongs to the second camp, the second camp task needing to be completed further includes destroying the virtual device in the virtual environment. Therefore, a user needs to control the first virtual object to damage the virtual device in the virtual environment, and prevent the virtual object of the first camp from maintaining the damaged virtual device before a countdown ends.

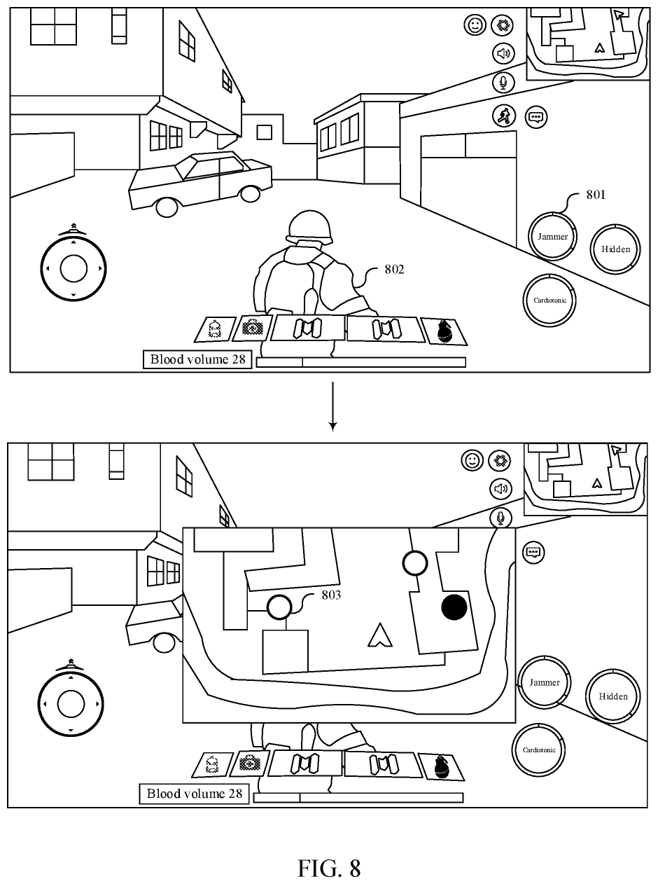

In certain embodiments, the virtual object of the second camp may remotely damage the virtual device. For example, the virtual object of the second camp may carry a virtual skill to remotely damage the virtual device. Schematically, as shown in FIG. 8, when the remote damage is performed, the device damage control is a “jammer” skill control 801. When the terminal receives a trigger operation on the “jammer” skill control 801, the virtual device with the smallest distance from a first virtual object 802 and the distance less than the distance threshold is determined as the target virtual device, and the target virtual device is damaged. In this case, a map representation interface is displayed, and device identifiers 803 of the virtual devices are displayed through the map representation interface. The device identifiers 803 can indicate the location of the virtual devices, and the identifiers of a damaged virtual device, a destroyed virtual device and a normal virtual device are different, so that the user can master the situation of the virtual devices.

Alternatively, when the terminal receives the trigger operation on the device damage control, the map representation interface is displayed, and the device identifier of the normal virtual device in the map representation interface may be triggered. When a trigger operation on the device identifier is received, and the distance between the corresponding virtual device and the first virtual object is less than the distance threshold, the terminal controls the first virtual object to damage the virtual device. That is, the virtual object of the second camp may remotely damage the nearby virtual device through the map representation interface.

To avoid that the user corresponding to the virtual object of the second camp always completes the second camp task by remote damage, after each time the virtual object of the second camp performs the remote damage, the remote damage may only be performed again after a preset duration, and the preset duration is variable. For example, a “jammer” skill has a skill cool-down duration.

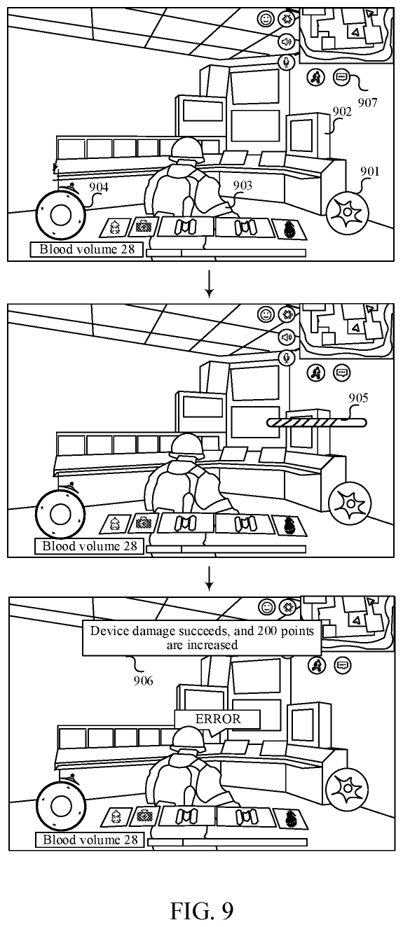

In certain embodiments, the user may further control the first virtual object to damage the virtual device at a close range. As shown in FIG. 9, a device damage control 901 and a direction control 904 are displayed in the object control interface. The user makes a first virtual object 903 to move in the virtual environment by triggering the direction control 904. When a distance between the first virtual object 903 and a target virtual device 902 (which is a normal device at this time) is less than the distance threshold, and a trigger operation on the device damage control 901 is received, the terminal starts countdown and displays a damage progress bar 905. If the distance between the first virtual object 903 and the target virtual device 902 is less than the distance threshold within a preset duration (such as, 3 seconds), it is determined that the target virtual device is damaged, and prompt information 906 of successful damage of the virtual device is displayed through the object control interface.

In certain embodiments, after the foregoing Operation 701, the method for controlling a virtual object further includes the following operations:
prominently displaying the target virtual device in the map representation control of the object control interface.

The object control interface includes the map representation control, where a map screen of the virtual environment within a preset range near the first virtual object is displayed. The terminal displays device identifiers of the virtual devices (such as, device thumbnails, device symbols, and the like) in the map screen, and prominently displays the target virtual device (for example, the color of the device identifier of the normal virtual device is different from that of the target virtual device), thereby facilitating the user to observe the situation of the virtual devices in the virtual environment.

Operation 704: Determine that the second camp task is completed, in response to the second virtual object being defeated by the first virtual object and the second virtual object belonging to the first camp.

The user defeats the second virtual object by controlling the first virtual object to use the virtual prop. If the second virtual object belongs to the first camp, it is determined that the first virtual object successfully completes the task of defeating the virtual object of the first camp once. If the second virtual object belongs to the second camp, the first virtual object does not complete the second camp task.

Operation 705: Determine that the second camp task is completed, in response to the target virtual device not being maintained within a countdown duration, where the target virtual device not being maintained within the countdown duration is destroyed.

In certain embodiments, the virtual object of the first camp needs to successfully maintain the device within the countdown duration, only after which can the target virtual device be restored to normal. If the virtual object of the first camp fails to maintain the target virtual device within the countdown duration, the target virtual device is determined to be destroyed, and the virtual object of the second camp that damages the target virtual device completes the second camp task once.

Operation 706: Display a game result through a game end interface, in response to the completed first camp task or the second camp task meeting a game end condition.

For the specific implementation of Operation 706, reference may be made to Operation 203, and details are not described again in this embodiment of this application.

In this embodiment of this application, when the trigger operation on the prop use control is received, the first virtual object is controlled to use the virtual prop, and the first virtual object can defeat the virtual objects of the first camp and the second camp. Only when the second virtual object belongs to the first camp, can the first virtual object be determined to complete the first camp task. Only after the first virtual object successfully destroys the target virtual device within the countdown duration, can the second camp task be determined to be completed. Thereby, the user may be urged to control the first virtual object to compete with the virtual object of the first camp, so as to effectively control the duration of a single game, and improve human-computer interaction efficiency and hardware resource utilization.

In certain embodiments, the virtual object of the second camp may obtain the camp information of other virtual objects of the camp. To facilitate communication between the users of the virtual objects of the second camp, and avoid exposing the camp information, the users can trigger to enter a camp channel of the second camp, thereby communicating within the camp and facilitate negotiation of a game strategy. When the first virtual object belongs to the second camp, the method for controlling a virtual object further includes the following operations:
switching to the camp channel, in response to a trigger operation on a channel switching control in the object control interface, where information published in the camp channel is visible to the virtual object belonging to the second camp and invisible to the virtual object belonging to the first camp.

Generally, a competitive battle game is arranged with a discussion method for the user participating in the game to communicate, including a text discussion area and a voice discussion. In the embodiments of this application, the virtual object of the first camp cannot obtain the camp information of the other virtual objects except for themselves, but the virtual object of the second camp can obtain the camp information of the other virtual objects in the second camp. Therefore, to facilitate communication between the users corresponding to the virtual objects of the second camp, the channel switching control is displayed in the object control interface.

In certain embodiments, an information sending method in the camp channel includes at least one of text sending and voice sending, and the content in the camp channel is invisible to the virtual object of the first camp.

Schematically, as shown in FIG. 9, a channel switching control 907 is displayed in the object control interface. When receiving a trigger operation on the channel switching control 907, if the camp channel is currently displayed, or if neither the camp channel nor a global channel is displayed, the terminal displays the global channel. If the global channel is currently displayed, the terminal switches to the camp channel.

In the foregoing embodiment, the first virtual object can complete the first camp task when defeating the virtual object of the rival camp. To avoid that the user competes at will, and uses a radical way to complete the camp task, when the first virtual object defeats the virtual object of the same camp, the first virtual object enters a debuff state. After the terminal executes the foregoing Operation 202 and controls the first virtual object to defeat other virtual objects, the method for controlling a virtual object in the embodiments of this application further includes the following three cases:

First, in response to the virtual object defeated by the first virtual object and the first virtual object belonging to the same camp, and the first virtual object being not in a debuff state, debuff prompt information is displayed in the object control interface, and the first virtual object is controlled to be in the debuff state.

When the virtual object defeated by the first virtual object and the first virtual object belong to the same camp, and the first virtual object is not in the debuff state, since the first virtual object defeats the virtual object of the same camp, the terminal controls the first virtual object to be in the debuff state, and displays the debuff prompt information on the object control interface, to prompt the user to be cautious in the game, and prevent a malicious competition of the user from causing confusion in the game.

When the first virtual object is in the debuff state, if the virtual object of the same camp is defeated again, the first virtual object is in a defeat state and cannot continue the game. If the virtual object of different camps is defeated, the first virtual object can release the debuff state.

Schematically, at least one attribute value of the first virtual object is reduced in the debuff state. For example, the remaining life value of the first virtual object is reduced by half, a traveling speed in the virtual environment is reduced by 20%, and a damage value of the virtual prop owned by the first virtual object is reduced by half.

Second, in response to the virtual object defeated by the first virtual object and the first virtual object belonging to the same camp, and the first virtual object being in a debuff state, defeat prompt information is displayed in the object control interface, and the first virtual object is controlled to be in the defeat state.

When the first virtual object is in the debuff state, and defeats the virtual object of the same camp, the first virtual object enters the defeat state and cannot continue the game. The terminal displays the defeat prompt information in the object control interface, and sets an operation control (such as the prop use control, the direction control, a device repair control, a device damage control, and the like) in the object control interface to a non-triggerable state.

Third, in response to the virtual object defeated by the first virtual object and the first virtual object belonging to different camps, and the first virtual object being in the debuff state, debuff elimination prompt information is displayed in the object control interface, and the first virtual object is controlled to release the debuff state.

When the first virtual object is in the debuff state and defeats the virtual object of different camps, the terminal controls the first virtual object to release the debuff state. Until the virtual object of the same camp is defeated next time, the first virtual object enters the debuff state again.

In the embodiments of this application, by setting a debuff mechanism, when the first virtual object defeats the virtual object of the same camp, the first virtual object enters the debuff state. If the first virtual object defeats the virtual object of the same camp again in the debuff state, the first virtual object is determined to be defeated, which can prevent the user from competing at will and using the radical way to complete the camp task.

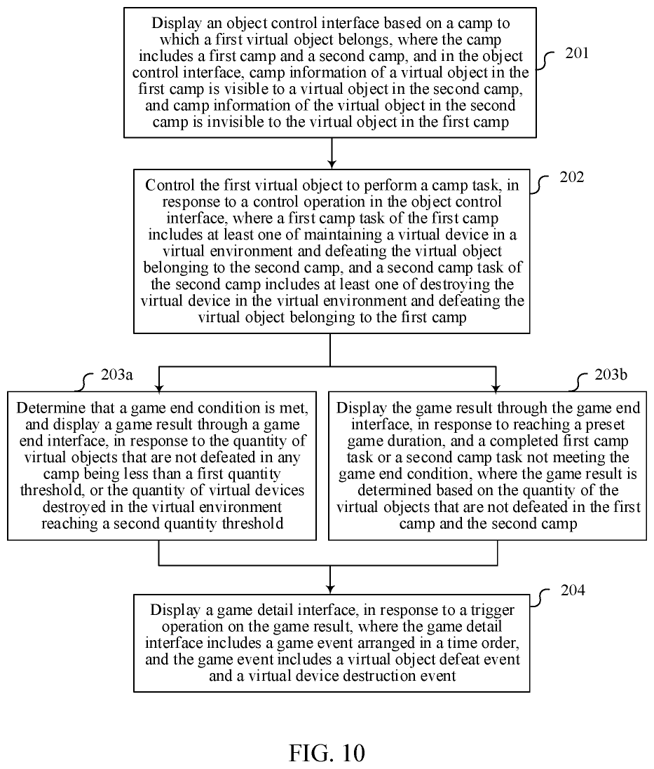

On the basis of FIG. 2, FIG. 10 is a flowchart of a method for controlling a virtual object according to another exemplary embodiment of this application. This embodiment is described by using an example in which the method is applied to the first terminal 110 or the second terminal 130 in the implementation environment shown in FIG. 1 or other terminals in the implementation environment. The method further includes the following operations:

Operation 203a: Determine that a game end condition is met, and display a game result through a game end interface, in response to the quantity of virtual objects that are not defeated in any camp being less than a first quantity threshold, or the quantity of virtual devices destroyed in a virtual environment reaching a second quantity threshold.

In certain embodiments, a game duration is set for each game. When the game duration is not reached but the quantity of the virtual objects that are defeated in one camp is less than the first quantity threshold, or the quantity of the virtual devices destroyed in the virtual environment reaches the second quantity threshold, the terminal determines that the game ends.

For example, the virtual object in the virtual environment have two different characters, which are divided into two camps: a “first character” and a “second character”. If all the “first character” is defeated, the game ends and the “second character” wins. If all the “second character” is defeated, the game ends and the “first character” wins. If there are three destroyed virtual devices in the virtual environment, the game ends and the “second character” wins.

Operation 203b: Display the game result through the game end interface, in response to reaching a preset game duration, and a completed first camp task or a second camp task not meeting the game end condition, where the game result is determined based on the quantity of the virtual objects that are not defeated in the first camp and the second camp.

In certain embodiments, to effectively control the duration of a single game and avoid that a passive battle between the two sides causes the duration of the single game to be exceedingly long, when the completed first camp task or the second camp task does not meet the game end condition but reaches the preset game duration, the terminal determines that the game ends, and determines the game result based on the quantity of the virtual objects that are not defeated in the first camp and the second camp. For example, if the quantity of the virtual objects that are not defeated in the first camp is greater than that of the second camp, the first camp wins. Otherwise, the second camp wins.

In certain embodiments, since the virtual object of the second camp can obtain camp information of the virtual objects, to avoid that a user corresponding to the virtual object of the second camp engages in the passive battle, the method for controlling a virtual object provided in the embodiments of this application further includes the following operations:
in response to no completed second camp task being within a target duration after the start of the game, updating the remaining duration of a current game to the target duration, where the target duration is less than the remaining duration of the current game.

For example, the duration of the single game is 8 minutes by default. The terminal starts timing after the start of the game. If the duration of the game reaches 2 minutes and there are no completed second camp task (that is, there are no defeated virtual objects and no damaged virtual devices in the first camp), the terminal updates the current remaining duration of 6 minutes to the target duration of 1 minute. That is, the duration of the single game is shortened from 8 minutes to 3 minutes.

Operation 204: Display a game detail interface, in response to a trigger operation on the game result, where the game detail interface includes a game event arranged in a time order, and the game event includes a virtual object defeat event and a virtual device destruction event.

In certain embodiments, when the terminal determines that the game ends, the game end interface is displayed, and the success or failure or draw of the camp to which the first virtual object belongs is displayed through the game end interface. When receiving a trigger operation on the game result, the game detail interface is displayed for the user to look back on.

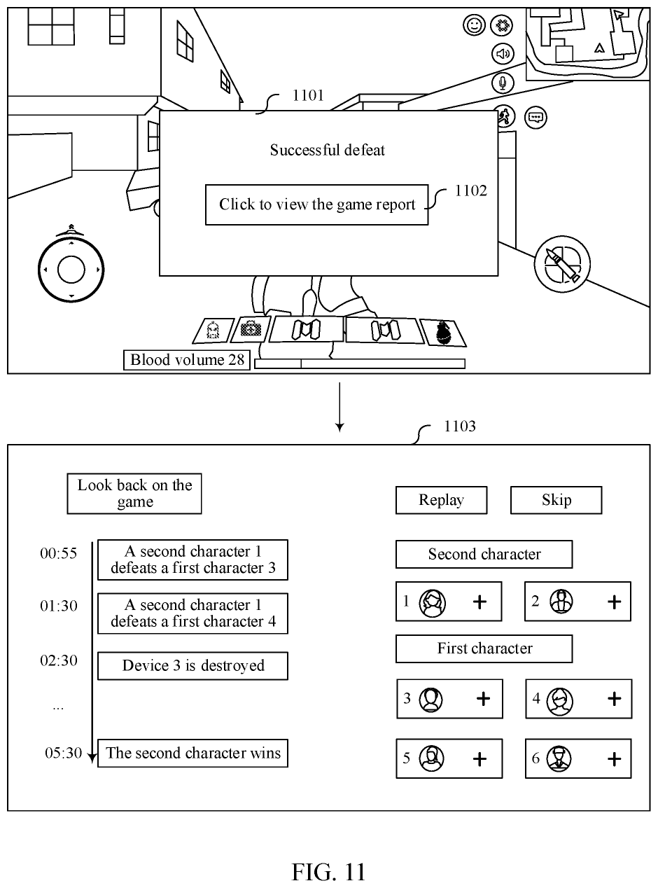

Schematically, as shown in FIG. 11, the terminal displays the game result through a game end interface 1101, where a control 1102 configured to trigger the display of a game detail interface 1103 is also displayed. When a trigger operation on the control 1102 is received, the terminal displays the game detail interface 1103. In the game detail interface 1103, a game event arranged in a chronological order is displayed on a left side, and the camp information of the virtual objects is displayed on a right side.

In the embodiments of this application, when the game duration is not reached, if task completion of any camp meets the game end condition, it is still determined that the game ends. The party who completes the camp task first wins. Otherwise, after the game duration is reached, the game result is determined based on the quantity of the virtual objects that are not defeated in both camps. In this case, on the basis of effectively controlling the game duration not to exceed the preset game duration, the user is urged to control the virtual object to compete, thus accelerating the process of the game.

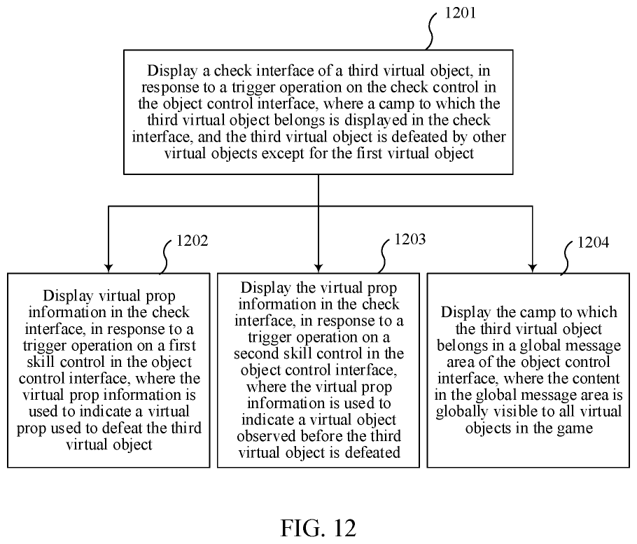

In certain embodiments, for the virtual objects of the first camp, the camp information of the virtual object that is not defeated currently is invisible, but the camp information of the defeated virtual object may be viewed in a preset manner, so that the user can speculate the camp information of the virtual object that is not defeated. FIG. 12 is a flowchart of a method for controlling a virtual object according to another exemplary embodiment of this application. This embodiment is described by using an example in which the method is applied to the first terminal 110 or the second terminal 130 in the implementation environment shown in FIG. 1 or other terminals in the implementation environment. The method further includes:

Operation 1201: Display a check interface of a third virtual object, in response to a trigger operation on the check control in the object control interface, where a camp to which the third virtual object belongs is displayed in the check interface, and the third virtual object is defeated by other virtual objects except for the first virtual object.

In certain embodiments, when a virtual object is defeated, other virtual objects except for the defeated party are needed to check information, and the camp information of the defeated virtual object is globally visible.

In certain embodiments, after the camp information of the defeated virtual object is disclosed, a virtual object defeating the virtual object may determine that the camp task is completed.

In certain embodiments, after the virtual object is defeated, the information may only be checked once.

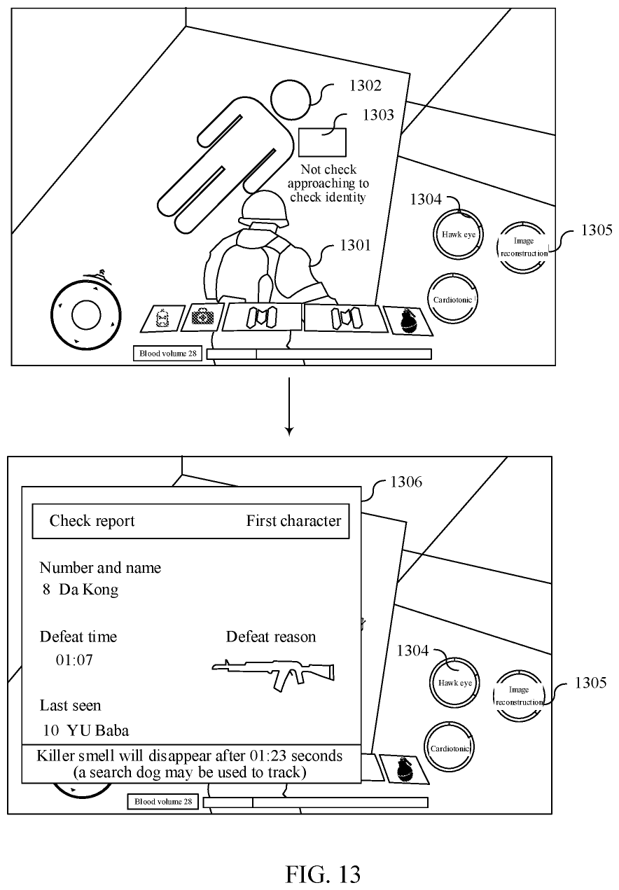

Schematically, as shown in FIG. 13, after a third virtual object 1302 is defeated, a check control 1303 is displayed nearby. The user triggers the check control 1303, causing the terminal to control the first virtual object 1301 to check the third virtual object 1302, and display a check interface 1306, which includes camp information “first character” of the third virtual object 1302.

In certain embodiments, when the first virtual object belongs to the first camp, the method for controlling a virtual object provided in the embodiments of this application further includes Operations 1202 and 1203.

Operation 1202: Display virtual prop information in the check interface, in response to a trigger operation on a first skill control in the object control interface, where the virtual prop information is used to indicate a virtual prop used to defeat the third virtual object.

In certain embodiments, by controlling the first virtual object to release a first skill, the user obtains the virtual prop information of the check interface, and knows the virtual prop used to defeat the third virtual object, so that the user can infer the virtual object that defeats the third virtual object based on the virtual prop information, and then infer the virtual object of the second camp.

The first skill is a skill carried by the first virtual object by default, or is obtained by the first virtual object picking up skill resources. A first activation duration is correspondingly set for the first skill. After the virtual object of the first camp obtains the first skill, the terminal starts timing, and the first skill control is in a non-triggerable state. When the first activation duration (such as, 2 minutes) is reached, the first skill control is switched to a triggerable state.

As shown in FIG. 13, when receiving a trigger operation on a first skill control 1304, the terminal displays the virtual prop that defeats the third virtual object 1302 through a check interface 1306.

Operation 1203: Display the virtual prop information in the check interface, in response to a trigger operation on a second skill control in the object control interface, where the virtual prop information is used to indicate a virtual object observed before the third virtual object is defeated.

In certain embodiments, by controlling the first virtual object to release a second skill, the user obtains the virtual object information of the check interface, and knows the virtual object observed before the third virtual object is defeated, so that the user can infer the virtual object that defeats the third virtual object based on the virtual object information, and then infer the virtual object of the second camp. The second skill is a skill carried by the first virtual object by default, or is obtained by the first virtual object picking up the skill resources. A second activation duration is correspondingly set for the second skill. After the virtual object of the first camp obtains the second skill, the terminal starts timing, and the second skill control is in the non-triggerable state. When the second activation duration (such as, 5 minutes) is reached, the second skill control is switched to the triggerable state.

As shown in FIG. 13, when receiving a trigger operation on a second skill control 1305, the terminal displays the virtual object observed before the third virtual object 1302 is defeated through the check interface 1306.

In certain embodiments, when the first virtual object belongs to the second camp, a third skill control is further displayed in the object control interface. The method for controlling a virtual object in the embodiments of this application further includes the following operations:
controlling the first virtual object to be in a hidden state, in response to a trigger operation on the third skill control in the object control interface, where a virtual object in the hidden state cannot be observed by other virtual objects.

The second skill is a skill carried by the second virtual object by default, or is obtained by the second virtual object picking up the skill resources. Therefore, when defeating the other virtual objects, the virtual object of the second camp may avoid being observed by the defeated virtual object by using the third skill. The virtual object information detected by the virtual object of the first camp using the second skill is not necessarily the virtual object that defeats the third virtual object.

In certain embodiments, the virtual object of the first camp may determine whether to disclose the information viewed by using the first skill and the second skill.

Operation 1204: Display the camp to which the third virtual object belongs in a global message area of the object control interface, where the content in the global message area is globally visible to all virtual objects in the game.

In certain embodiments, after the defeated virtual object in the virtual environment is checked by the other virtual objects (the virtual object of the first camp or the virtual object of the second camp), the terminal automatically displays the camp to which the third virtual object belongs through the global message area, so that the user can understand the current game situation. When the virtual object of the first camp selects to disclose the virtual prop information and the virtual object information of the check interface, the terminal displays the corresponding message through the global message area.

In the embodiments of this application, when the trigger operation on the check control is received, the camp information of the third virtual object is displayed through the check interface and globally disclosed, so that the user can understand the current game situation; When the first virtual object belongs to the first camp, the virtual prop that defeats the third virtual object and the last virtual object observed by the third virtual object may be viewed through the skill, so that the user corresponding to the virtual object of the first camp can infer the virtual object contained in the second camp. In addition, the virtual object that defeats the third virtual object cannot check the third virtual object, which can avoid the situation that the user uses a location advantage to check immediately after defeating the virtual object and hinders the other virtual objects from obtaining the check information.

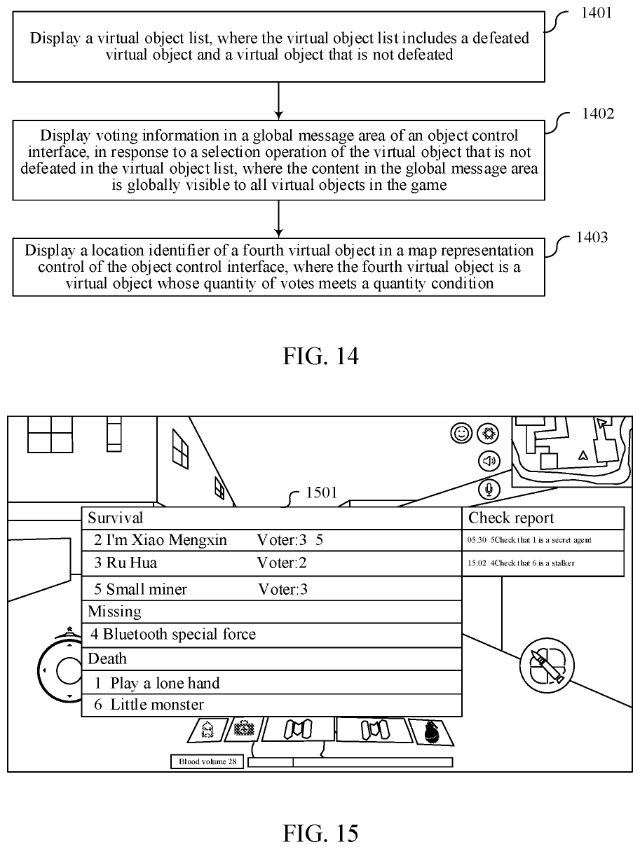

In certain embodiments, the method for controlling a virtual object provided in the embodiments of this application includes a voting mechanism. That is, the users may vote for the virtual object that may belong to the second camp, so that the user corresponding to the virtual object of the first camp can feed back clues to the other users of the camp. In this case, the user corresponding to the virtual object of the second camp may also confuse the camp information by voting for the virtual object of the first camp. FIG. 14 is a flowchart of a method for controlling a virtual object according to certain embodiments of this application. This embodiment is described by using an example in which the method is applied to the first terminal 110 or the second terminal 130 in the implementation environment shown in FIG. 1 or other terminals in the implementation environment. The method further includes the following operations:

Operation 1401: Display a virtual object list, where the virtual object list includes a defeated virtual object and a virtual object that is not defeated.

In certain embodiments, when receiving a trigger operation on a list display control, the terminal displays the virtual object list. The virtual object list includes the defeated virtual object and the virtual object that is not defeated. Schematically, as shown in FIG. 15, in the virtual object list 1501, the virtual object that is not defeated, the defeated virtual object that is checked, and the defeated virtual object that is not checked are displayed in categories, and the camp information of the virtual objects that are checked and a checker are displayed on a right side.

Operation 1402: Display voting information in a global message area of an object control interface, in response to a selection operation of the virtual object that is not defeated in the virtual object list, where the content in the global message area is globally visible to all virtual objects in the game.

In certain embodiments, the method for controlling a virtual object provided in the embodiments of this application includes a voting mechanism. That is, users may vote on the virtual object by triggering the virtual object list, and the voting is used to indicate that a voter thinks that a voted party belongs to a second camp. When the terminal receives the selection operation of the virtual object that is not defeated in the virtual object list, the voting information is displayed in the global message area of the object control interface, and the voting information in the virtual object list is updated. As shown in FIG. 15, in a virtual object list 1501, the voting information is displayed corresponding to the virtual object that is not defeated, including the number of the virtual object that votes to determine that the virtual object belongs to the second camp.

In certain embodiments, the user can vote through the virtual object list at any time; or, the terminal sets the virtual object list to a voting state after detecting that a third virtual object is checked in the virtual environment.

Operation 1403: Display a location identifier of a fourth virtual object in a map representation control of the object control interface, where the fourth virtual object is a virtual object whose quantity of votes meets a quantity condition.

For the virtual object whose quantity of votes meets the quantity condition, the location information is displayed globally, so that the user corresponding to the virtual object of the first camp can control the virtual object to defeat it. The quantity condition is that a quantity threshold is exceeded, or a current quantity of votes is the maximum.

In certain embodiments, the virtual object may also enter a gain state through a preset manner, and the virtual object in the gain state has a higher attribute value. After the foregoing Operation 202, the method for controlling a virtual object in the embodiments of this application may further include the following operations:

Operation 1: Perform, in response to a first virtual object completing a camp task, skill charging for a target skill of the first virtual object.

In certain embodiments, the first virtual object may obtain a corresponding point after completing the camp task once, and the amount of the points corresponding to different camp tasks may be different. For example, if the first virtual object belongs to the first camp, every time the first virtual object defeats a virtual object of a second camp, one hundred points can be obtained. Every time a virtual device is successfully maintained, two hundred points can be obtained. In addition, the first virtual object can obtain fifty points by checking a third virtual object. When the virtual object of the second camp is defeated for the first time globally, all the virtual objects of the first camp can obtain one hundred points. The terminal performs the skill charging based on the amount of the points of the first virtual object. The amount of the skill charging is positively related to the amount of the points.

In certain embodiments, in addition to the skill charging by completing the camp task, the target skill of the first virtual object is automatically charged at a preset charging rate as a game duration increases.

Operation 2: Setting the fourth skill control to a triggerable state, in response to a charging state of the target skill meeting a release condition.

When the charging state of the target skill meets the release condition, the terminal sets the fourth skill control to the triggerable state. In certain embodiments, the terminal prompts the user to control the first virtual object to release a fourth skill by displaying prompt information or prominently displaying the fourth skill control.

Operation 3: control the first virtual object to release the target skill, in response to a trigger operation on the fourth skill control, where after releasing the target skill, the first virtual object is in the gain state, and the camp information of the first virtual object is globally visible.

When the first virtual object is in the gain state after releasing the target skill, to avoid a high probability of winning for the virtual object in the gain state, the camp information of the first virtual object is globally visible after releasing the target skill.

In certain embodiments, the terminal displays camp information of the virtual object after the fourth skill is released through the global message area; or, the terminal binds a camp display identifier to the virtual object that releases the fourth skill in the virtual environment.

In the gain state, the attribute values of the first virtual object are higher than an attribute value in a default state. For example, if the first virtual object belongs to the first camp, after the first virtual object releases the fourth skill, a running speed is increased by 20%. The remaining health value increases to an initial health value. A relevant skill of the first camp that is not obtained is automatically activated. A damage value of an owned virtual prop is doubled. If the first virtual object belongs to the second camp, after releasing the fourth skill, the first virtual object generates smoke in a preset range near the first virtual object, which is used to reduce the field of view and health value compared with other virtual objects. The running speed is increased by 20%. The remaining health value is increased to the original health value. A skill cooling effect is cleared. A mechanism of global disclosure of location information when the quantity of the votes is the largest is cleared.

In the embodiments of this application, the defeated virtual object and the virtual object that is not defeated, a check event in the game process, and the voting information of the virtual objects are displayed through the virtual object list, so that the user can obtain the current game situation in real time. Judgment results of the users are displayed by using the voting mechanism, and the location information of the virtual object whose quantity of votes meets the quantity condition is set to be globally visible, which can provide clues for the users to judge the camp information, thereby accelerating the game process.

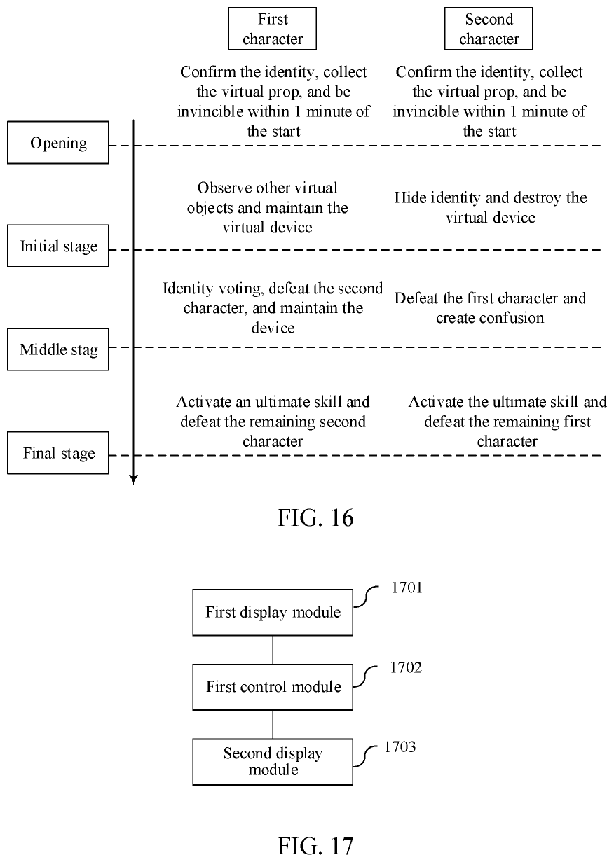

Schematically, FIG. 16 is a game flowchart using a method for controlling a virtual object according to this application. In the game, the virtual object has two different characters, namely, the first character (the first camp) and the second character (the second camp). Identity information of the first character is visible to the second character, but the camp information of the second character is invisible to the first character.

In an opening stage, the first character and the second character first clarify their own identities (that is, the camp information). The virtual objects are equipped with the same initial virtual props. There are many types of virtual props scattered randomly in the virtual environment. Both the first character and the second character can pick up and equip a certain quantity of virtual props, which is convenient for defeating the rival virtual object by using the virtual props in a later stage. Within one minute after the opening, both the first character and the second character are invincible. That is, when attacked by the other virtual objects, a target attribute value (such as, health value) remains unchanged, so that users can collect resources in the opening stage.

In an initial stage, the second character hides the identity and waits for an opportunity to damage the virtual device in the virtual environment. The second character completes the camp task by preventing the first character from maintaining the virtual device to destroy the virtual device. The first character maintains the damaged virtual device in the virtual environment, and observes the behavior of the other virtual objects to infer the camp information of the other virtual objects. In addition, the player can check the identity of the virtual object defeated by the other virtual objects, to obtain the camp information of the defeated virtual object, the virtual prop used to defeat the virtual object, and the virtual object observed by the defeated virtual object, thereby inferring the second character.

In a middle stage, the player of the first character camp attack the virtual object suspected of belonging to the second character by controlling the virtual object to use the virtual prop. By defeating the second character and maintaining the virtual device accelerates the energy accumulation of an ultimate skill. The virtual object suspected of belonging to the second character may be voted by identity voting to feed back clues to the other first characters. The second character also accumulates the energy of the ultimate skill by using the virtual prop to defeat the first character and destroying the virtual device. At the same time, confusion may be created through the voting mechanism and the camp information may be hidden.

In a final stage, when the energy accumulation meets a trigger condition om the ultimate skill, the ultimate skill may be activated. After the virtual object activates the ultimate skill, the attribute value (such as health value, movement speed, force value of the virtual prop, and the like) is greatly increased, and the camp information is exposed. The first character and the second character attack each other based on the globally visible camp information to win the game.

FIG. 17 is a structural block diagram of an apparatus for controlling a virtual object according to certain embodiments of this application. The apparatus may include:
a first display module 1701, configured to display an object control interface based on a camp to which a first virtual object belongs, where the camp includes a first camp and a second camp, and in the object control interface, camp information of a virtual object in the first camp is visible to a virtual object in the second camp, and camp information of the virtual object in the second camp is invisible to the virtual object in the first camp;
a first control module 1702, configured to control the first virtual object to perform a camp task, in response to a control operation in the object control interface, where a first camp task of the first camp includes at least one of maintaining a virtual device in a virtual environment and defeating the virtual object belonging to the second camp, and a second camp task of the second camp includes at least one of destroying the virtual device in the virtual environment and defeating the virtual object belonging to the first camp; and
a second display module 1703, configured to display a game result through a game end interface, in response to the completed first camp task or the second camp task meeting a game end condition.

In certain embodiments, the first virtual object belongs to the first camp, and a prop use control and a device maintenance control are displayed in the object control interface.

The first control module 1702 may include:
a first control unit, configured to control the first virtual object to use a virtual prop for a second virtual object, in response to a trigger operation on the prop use control in the object control interface, where the virtual prop is used to reduce an attribute value of the virtual object, and the second virtual object belongs to the first camp or the second camp; and
a second control unit, configured to control the first virtual object to maintain the target virtual device, in response to a trigger operation on the device maintenance control in the object control interface and a distance between the first virtual object and a target virtual device being less than a distance threshold, where the target virtual device is a virtual device to be maintained, or is randomly determined, or is damaged by the virtual object of the second camp.

In certain embodiments, the apparatus further includes:
a first determining module, configured to determine that the first camp task is completed, in response to the second virtual object being defeated by the first virtual object and the second virtual object belonging to the second camp; and
a second determining module, configured to determine that the first camp task is completed, in response to the target virtual device being maintained within a countdown duration.

In certain embodiments, the first virtual object belongs to the second camp, and the prop use control and a device damage control are displayed in the object control interface.

The first control module 1702 may include:
a third control unit, configured to control the first virtual object to use the virtual prop for the second virtual object, in response to the trigger operation on the prop use control in the object control interface, where the virtual prop is used to reduce the attribute value of the virtual object, and the second virtual object belongs to the first camp or the second camp; and
a fourth control unit, configured to determine the virtual device with a smallest distance from the first virtual object and the distance less than the distance threshold as the target virtual device, and control the first virtual object to damage the target virtual device, in response to a trigger operation on the device damage control in the object control interface.

In certain embodiments, the apparatus further includes:
a third determining module, configured to determine that the second camp task is completed, in response to the second virtual object being defeated by the first virtual object and the second virtual object belonging to the first camp; and
a fourth determining module, configured to determine that the second camp task is completed, in response to the target virtual device not being maintained within the countdown duration, where the target virtual device not being maintained within the countdown duration is destroyed.

In certain embodiments, the apparatus further includes:
a third display module, configured to prominently display the target virtual device in a map representation control of the object control interface.

In certain embodiments, the second display module 1703 includes:
a display unit, configured to determine that the game end condition is met, and displaying the game result through the game end interface in response to the quantity of virtual objects that are not defeated in any camp being less than a first quantity threshold, or the quantity of virtual devices destroyed in the virtual environment reaching a second quantity threshold.

In certain embodiments, the apparatus further includes:
a fourth display module, configured to display the game result through the game end interface, in response to reaching a preset game duration, and the completed first camp task or the second camp task not meeting the game end condition, where the game result is determined based on the quantity of the virtual objects that are not defeated in the first camp and the second camp.

In certain embodiments, a check control is displayed in the object control interface.

The apparatus further includes:
a fifth display module, configured to display a check interface of a third virtual object, in response to a trigger operation of the check control in the object control interface, where a camp to which the third virtual object belongs is displayed in the check interface, and the third virtual object is defeated by other virtual objects except for the first virtual object; and
a sixth display module, configured to display the camp to which the third virtual object belongs in a global message area of the object control interface, where the content in the global message area is globally visible to all virtual objects in the game.

In certain embodiments, the first virtual object belongs to the first camp, and a first skill control and a second skill control are displayed in the object control interface.

The apparatus further includes:
a seventh display module, configured to display virtual prop information in the check interface, in response to a trigger operation on the first skill control in the object control interface, where the virtual prop information is used to indicate the virtual prop used to defeat the third virtual object;
an eighth display module, configured to display virtual prop information in the check interface, in response to a trigger operation on the second skill control in the object control interface, where the virtual prop information is used to indicate the virtual object observed before the third virtual object is defeated.

In certain embodiments, the first virtual object belongs to the second camp, and a third skill control is displayed in the object control interface.

The apparatus further includes:
a second control module, configured to control the first virtual object to be in a hidden state, in response to a trigger operation on the third skill control in the object control interface, where the virtual object in the hidden state cannot be observed by the other virtual objects.

In certain embodiments, the apparatus further includes:
a ninth display module, configured to display a virtual object list, where the virtual object list includes a defeated virtual object and a virtual object that is not defeated;
a tenth display module, configured to display voting information in a global message area of the object control interface, in response to a selection operation of the virtual object that is not defeated in the virtual object list, where the content in the global message area is globally visible to all virtual objects in the game. and
an eleventh display module, configured to display a location identifier of a fourth virtual object in the map representation control of the object control interface, where the fourth virtual object is a virtual object whose quantity of votes meets a quantity condition.

In certain embodiments, the apparatus further includes:
a twelfth display module, configured to display debuff prompt information in the object control interface, in response to the virtual object defeated by the first virtual object and the first virtual object belonging to the same camp, and the first virtual object being not in a debuff state, and controlling the first virtual object to be in the debuff state;
a thirteenth display module, configured to display defeat prompt information in the object control interface, in response to the virtual object defeated by the first virtual object and the first virtual object belonging to the same camp, and the first virtual object being not in a debuff state, and controlling the first virtual object to be in a defeat state; and
a fourteenth display module, configured to display debuff elimination prompt information in the object control interface, in response to the virtual object defeated by the first virtual object and the first virtual object belonging to different camps, and the first virtual object being in a debuff state, and controlling the first virtual object to release the debuff state.

In certain embodiments, a fourth skill control is further displayed in the object control interface, where the fourth skill control is configured to trigger the first virtual object to release a target skill, and an initial state of the fourth skill control is a non-triggerable state.

The apparatus further includes:
a first setting module, configured to perform skill charging for the target skill of the first virtual object, in response to the first virtual object completing the camp task;
a second setting module, configured to set the fourth skill control to a triggerable state, in response to a charging state of the target skill meeting a release condition; and
a third control module, configured to control the first virtual object to release the target skill, in response to the trigger operation on the fourth skill control, where after releasing the target skill, the first virtual object is in a gain state, and the camp information of the first virtual object is globally visible.

In certain embodiments, the first virtual object belongs to the second camp, and a channel switching control is displayed in the object control interface.

The apparatus further includes:
a switching module, configured to switch to a camp channel, in response to a trigger operation on the channel switching control in the object control interface, where information published in the camp channel is visible to the virtual object belonging to the second camp and invisible to the virtual object belonging to the first camp.

In certain embodiments, the apparatus further includes:
a fifteenth display module, configured to display a game detail interface, in response to a trigger operation on the game result, where the game detail interface includes a game event arranged in a time order, and the game event includes a virtual object defeat event and a virtual device destruction event.

In certain embodiments, the apparatus further includes:
an updating module, configured to update the remaining duration of a current game to the target duration, in response to no completed second camp task being within a target duration after the start of the game, where the target duration is less than the remaining duration of the current game.

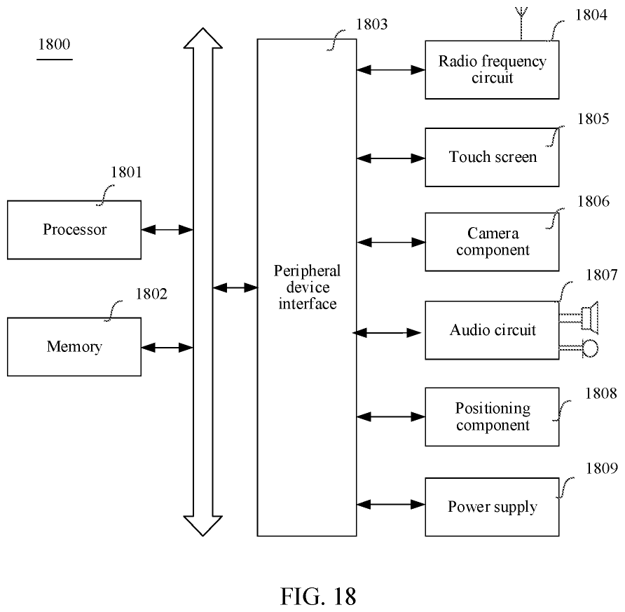

FIG. 18 is a structural block diagram of a terminal 1800 according to certain embodiments of this application. The terminal 1800 may be a portable mobile terminal, such as: a smart phone, a tablet PC, a Moving Picture Experts Group Audio Layer III (MP3) player, a Moving Picture Experts Group Audio Layer IV (MP4) player. The terminal 1800 may be further referred to as other names such as user equipment and a portable terminal.

Generally, the terminal 1800 includes: a processor 1801 and a memory 1802.

The processor 1801 may include one or more processing cores, such as, a 4-core processor or an 8-core processor. The processor 1801 may be implemented by using at least one hardware form of digital signal processing (DSP), a field-programmable gate array (FPGA), and a programmable logic array (PLA). The processor 1801 may further include a main processor and a coprocessor. The main processor is a processor configured to process data in an active state, also referred to as a central processing unit (CPU). The coprocessor is a low-power processor configured to process data in a standby state. In certain embodiments, the processor 1801 may be integrated with a graphics processing unit (GPU). The GPU is configured to render and draw content that needs to be displayed on a display screen. In certain embodiments, the processor 1801 may further include an artificial intelligence (AI) processor. The AI processor is configured to process computing operations related to machine learning.

The memory 1802 may include one or more computer-readable storage media. The computer-readable storage medium may be tangible and non-transient. The memory 1802 may further include a high-speed random access memory and a non-volatile memory, such as, one or more disk storage devices or flash memory devices. In certain embodiments, the non-transitory computer-readable storage medium in the memory 1802 is configured to store at least one instruction, and the at least one instruction is configured to be executed by the processor 1801 to implement the method provided in the embodiments of this application.

In certain embodiments, the terminal 1800 may optionally include: a peripheral interface 1803 and at least one peripheral device. Specifically, the peripheral device includes: at least one of a radio frequency circuit 1804, a touch display screen 1805, a camera assembly 1806, an audio circuit 1807, a positioning assembly 1808, and a power supply 1809.

A person skilled in the art may understand that the structure shown in FIG. 18 constitutes no limitation on the terminal 1800, and the terminal may include more or fewer components than those shown in the figure, or certain components may be combined, or a different component deployment may be used.

The embodiments of this application further provide a computer-readable storage medium, storing at least one instruction, the at least one instruction being loaded and executed by a processor to implement the method for controlling a virtual object provided in the embodiments of this application.

The embodiments of this application further provide a computer program product or a computer program. The computer program product or the computer program includes computer instructions, and the computer instructions are stored in a computer-readable storage medium. A processor of a terminal reads the computer instructions from the computer-readable storage medium, and executes the computer instructions, causing the terminal to implement the method for controlling a virtual object provided in the embodiments of this application.

A person skilled in the art may be aware that in the one or more examples, the functions described in the embodiments of this application may be implemented by using hardware, software, firmware, or any combination thereof. When implemented by using software, the functions can be stored in a computer-readable storage medium or can be used as one or more instructions or code in a computer-readable storage medium for transmission. The computer-readable storage medium includes a computer storage medium and a communication medium, where the communication medium includes any medium that enables a computer program to be transmitted from one place to another. The storage medium may be any available medium accessible to a general-purpose or dedicated computer.

The foregoing descriptions are merely optional embodiments of this application, but are not intended to limit this application. Any modification, equivalent replacement, and improvement made within the spirit and principle of this application shall fall within the protection scope of this application.

What is claimed is:

1. A method for controlling a virtual object, executed by a terminal, the method comprising:
displaying an object control interface based on a camp to which a first virtual object belongs, the camp including a first camp and a second camp;
controlling the first virtual object to execute a camp task corresponding to the camp to which the first virtual object belongs, in response to a control operation in the object control interface, wherein a first camp task of a plurality of camp tasks and corresponding to the first camp includes at least one of maintaining a virtual device in a virtual environment and defeating the virtual object belonging to the second camp, and a second camp task of the plurality of camp tasks and corresponding to the second camp includes at least one of destroying the virtual device in the virtual environment and defeating the virtual object belonging to the first camp; and
displaying a game result through a game end interface, in response to the executed camp task meeting a game end condition.

2. The method according to claim 1,
wherein the first virtual object belongs to the first camp;
wherein a prop use control and a device maintenance control are displayed in the object control interface; and
wherein the controlling of the first virtual object to execute the camp task includes:
controlling the first virtual object to use a virtual prop for a second virtual object, in response to a trigger operation on the prop use control in the object control interface, the virtual prop being used to reduce an attribute value of the virtual object, and
controlling the first virtual object to maintain a target virtual device, in response to: a trigger operation on the device maintenance control in the object control interface, and a distance between the first virtual object and the target virtual device being less than a distance threshold.

3. The method according to claim 2, further comprising, after the controlling of the first virtual object to execute the camp task in response to the control operation in the object control interface:
determining that the first camp task is completed, in response to the second virtual object being defeated by the first virtual object and the second virtual object belonging to the second camp; and
determining that the first camp task is completed, in response to the target virtual device being maintained within a countdown duration.

4. The method according to claim 1,
wherein the first virtual object belongs to the second camp;
wherein a prop use control and a device damage control are displayed in the object control interface; and
wherein the controlling of the first virtual object to execute the camp task in response to the control operation in the object control interface, includes:
controlling the first virtual object to use a virtual prop for a second virtual object, in response to a trigger operation on the prop use control in the object control interface, the virtual prop being used to reduce an attribute value of the virtual object,
determining a virtual device of a plurality of virtual devices to be a target virtual device based on a distance from the first virtual object being less than a distance threshold and being a smallest distance of a plurality of distances respectively corresponding to the plurality of virtual devices, and
controlling the first virtual object to damage the target virtual device, in response to a trigger operation on the device damage control in the object control interface.

5. The method according to claim 4, further comprising, after the controlling of the first virtual object to execute the camp task in response to the control operation in the object control interface:
determining that the second camp task is completed, in response to the second virtual object being defeated by the first virtual object and the second virtual object belonging to the first camp; and
determining that the second camp task is completed, in response to the target virtual device not being maintained within a countdown duration, wherein the target virtual device not being maintained within the countdown duration is destroyed.

6. The method according to claim 2, further comprising, after the displaying of the object control interface based on the camp to which the first virtual object belongs:
displaying the target virtual device by using a target display style in the object control interface, wherein the target display style of the target virtual device is different from a display style of another virtual device.

7. The method according to claim 1,
wherein the displaying of the game result through the game end interface in response to the executed camp task meeting the game end condition includes:
determining that the executed camp task meets the game end condition, and displaying the game result through the game end interface, in response to at least one of: a quantity of virtual objects that are not defeated in any camp being less than a first quantity threshold, and a quantity of virtual devices destroyed in the virtual environment reaching a second quantity threshold.

8. The method according to claim 1, further comprising:
displaying the game result through the game end interface, in response to an execution duration of the camp task reaching a preset game duration and the executed camp task not meeting the game end condition, the game result being determined based on a quantity of virtual objects that are not defeated in the first camp and the second camp.

9. The method according to claim 1,
wherein a check control is displayed in the object control interface; and
wherein the method further comprises:
displaying a check interface of a third virtual object, in response to a trigger operation on the check control in the object control interface, a camp to which the third virtual object belongs being displayed in the check interface, and the third virtual object being defeated by other virtual objects except for the first virtual object, and
displaying the camp to which the third virtual object belongs in a global message area of the object control interface.

10. The method according to claim 9,
wherein the first virtual object belongs to the first camp;
wherein a first skill control and a second skill control are displayed in the object control interface; and
wherein the method further comprises, after the displaying of the check interface of the third virtual object, at least one of:
displaying first virtual prop information in the check interface, in response to a trigger operation on the first skill control in the object control interface, the first virtual prop information being used to indicate a virtual prop used to defeat the third virtual object, and
displaying second virtual prop information in the check interface, in response to a trigger operation on the second skill control in the object control interface, the second virtual prop information being used to indicate a virtual object observed before the third virtual object is defeated.

11. The method according to claim 1,
wherein the first virtual object belongs to the second camp;
wherein a third skill control is displayed in the object control interface; and
wherein the method further comprises:
controlling the first virtual object to be in a hidden state, in response to a trigger operation on the third skill control in the object control interface, wherein a virtual object in the hidden state cannot be observed by other virtual objects.

12. The method according to claim 1, further comprising:
displaying a virtual object list, the virtual object list comprising a defeated virtual object and a virtual object that is not defeated;
displaying voting information in a global message area of the object control interface, in response to a selection operation on the virtual object that is not defeated in the virtual object list; and
displaying a location identifier of a fourth virtual object in a map representation control of the object control interface, the fourth virtual object being a virtual object whose quantity of votes meets a quantity condition.

13. The method according to claim 1, further comprising, after the controlling of the first virtual object to execute the camp task in response to the control operation in the object control interface:
displaying debuff prompt information in the object control interface, in response to the virtual object defeated by the first virtual object and the first virtual object belonging to the same camp, and the first virtual object being not in a debuff state;
controlling the first virtual object to be in the debuff state;
displaying defeat prompt information in the object control interface, in response to the virtual object defeated by the first virtual object and the first virtual object belonging to the same camp, and the first virtual object being not in the debuff state;
controlling the first virtual object to be in a defeat state;
displaying debuff elimination prompt information in the object control interface, in response to the virtual object defeated by the first virtual object and the first virtual object belonging to different camps, and the first virtual object being in the debuff state; and
controlling the first virtual object to release the debuff state.

14. The method according to claim 1,
wherein a fourth skill control is further displayed in the object control interface, the fourth skill control being configured to trigger the first virtual object to release a target skill, an initial state of the fourth skill control being a non-triggerable state; and
wherein the method further comprises, after the controlling of the first virtual object to execute the camp task in response to the control operation in the object control interface:
performing skill charging for the target skill of the first virtual object, in response to the first virtual object completing the camp task;
setting the fourth skill control to a triggerable state, in response to a charging state of the target skill meeting a release condition; and
controlling the first virtual object to release the target skill, in response to a trigger operation on the fourth skill control.

15. The method according to claim 1,
wherein the first virtual object belongs to the second camp;
wherein a channel switching control is displayed in the object control interface; and
wherein the method further comprises:
switching to a camp channel, in response to a trigger operation on the channel switching control in the object control interface, wherein information published in the camp channel is visible to the virtual object belonging to the second camp and invisible to the virtual object belonging to the first camp.

16. The method according to claim 1, further comprising, after the displaying of the game result through the game end interface:
displaying a game detail interface, in response to a trigger operation on the game result, wherein the game detail interface includes information on at least one game event arranged in a time order, and the at least one game event includes at least one of a virtual object defeat event and a virtual device destruction event.

17. The method according to claim 1, further comprising:
updating, in response to no completed second camp task being within a target duration after a start time of a current game, a remaining duration of the current game based on the target duration, the target duration being less than the remaining duration of the current game.

18. An apparatus for controlling a virtual object comprising:
at least one memory configured to store computer program code;
at least one processor configured to operate as instructed by the computer program code, the computer program code including:
first display code configured to cause the at least one processor to display an object control interface based on a camp to which a first virtual object belongs, the camp including a first camp and a second camp;
first control code configured to cause the at least one processor to control the first virtual object to perform a camp task, in response to a control operation in the object control interface, wherein a first camp task of a plurality of camp tasks and corresponding to the first camp includes at least one of maintaining a virtual device in a virtual environment and defeating the virtual object belonging to the second camp, and a second camp task of the plurality of camp tasks and corresponding to the second camp includes at least one of destroying the virtual device in the virtual environment and defeating the virtual object belonging to the first camp; and
second display code configured to cause the at least one processor to display a game result through a game end interface, in response to the executed camp task meeting a game end condition.

19. The apparatus according to claim 18,
wherein the first virtual object belongs to the first camp;
wherein a prop use control and a device maintenance control are displayed in the object control interface;
wherein the controlling of the first virtual object to execute the camp task includes controlling the first virtual object to use a virtual prop for a second virtual object, in response to a trigger operation on the prop use control in the object control interface, the virtual prop being used to reduce an attribute value of the virtual object; and
wherein the first control code is configured to cause the at least one processor to control the first virtual object to maintain a target virtual device, in response to: a trigger operation on the device maintenance control in the object control interface, and a distance between the first virtual object and the target virtual device being less than a distance threshold.

20. A non-transitory computer-readable storage medium storing computer program code that when executed by at least one processor causes the at least one processor to:
display an object control interface based on a camp to which a first virtual object belongs, the camp including a first camp and a second camp;
control the first virtual object to execute a camp task corresponding to the camp to which the first virtual object belongs, in response to a control operation in the object control interface, wherein a first camp task of a plurality of camp tasks and corresponding to the first camp includes at least one of maintaining a virtual device in a virtual environment and defeating the virtual object belonging to the second camp, and a second camp task of the plurality of camp tasks and corresponding to the second camp includes at least one of destroying the virtual device in the virtual environment and defeating the virtual object belonging to the first camp; and
display a game result through a game end interface, in response to the executed camp task meeting a game end condition.
